(19) United States
(12) Patent Application Publication
(10) Pub. No.: US 2026/0040140 A1
(43) Pub. Date: Feb. 5, 2026

(54) METHOD FOR TIMER ADJUSTMENT IN PACKET TRANSMISSION AND USER EQUIPMENT USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW); Fang-Ching Ren, Hsinchu City (TW)

(73) Assignee: Industrial Technology Research Institute, Hsinchu (TW)

(21) Appl. No.: 19/286,254

(22) Filed: Jul. 31, 2025

Related U.S. Application Data
(60) Provisional application No. 63/678,065, filed on Aug. 1, 2024.
(60) Provisional application No. 63/730,966, filed on Dec. 12, 2024.

(51) Int. Cl. H04W 28/06; H04W 56/00; H04W 72/566

(52) U.S. Cl. CPC H04W 28/06; H04W 56/0015; H04W 72/566

(57) ABSTRACT

A method for timer adjustment in packet transmission and a user equipment are provided. The method includes: obtaining a plurality of service data units comprising a first service data unit; initializing a discard timer corresponding to the first service data unit of a first traffic type; performing logical channel prioritization to select a second service data unit from the plurality of service data units; determining a second traffic type of the second service data unit; and in response to determining the second traffic type, adjusting the discard timer for the first service data unit in a buffer.

### CROSS-REFERENCE TO RELATED APPLICATION

This application claims the priority benefit of U.S. provisional application Ser. No. 63/678,065, filed on Aug. 1, 2024 and U.S. provisional application Ser. No. 63/730,966, filed on Dec. 12, 2024. The entirety of each of the above-mentioned patent applications is hereby incorporated by reference herein and made a part of this specification.

### BACKGROUND

### Technical Field

The disclosure is directed to a method for timer adjustment in packet transmission and a user equipment (UE).

### Description of Related Art

Multi-modal data of multi-modal communication services is defined to describe the input data from different kinds of devices/sensors or the output data to different kinds of destinations (e.g., one or more UEs) required for the same task or application. Multi-modal data consists of more than one single-modal data, and there is strong dependency among each single-modal data, wherein a single-modal data can be seen as one type of data (e.g., data corresponding to the same traffic type). For immersive multi-modal virtual reality (VR) applications, synchronization between different media components is critical to ensuring a seamless user experience. A lack of synchronization can negatively impact user perception, particularly when the synchronization threshold between multiple modalities is lower than the latency key performance indicator (KPI) of the applications. Therefore, achieving precise synchronization of multi-modal data corresponding to the same service is a crucial challenge.

### SUMMARY

The disclosure provides a method for timer adjustment in packet transmission and a UE using the same method. The disclosure may ensure the synchronization for the multi-modal communication services.

The present disclosure is directed to a method for timer adjustment in packet transmission suitable for a user equipment. The method includes: obtaining a plurality of service data units including a first service data unit; initializing a discard timer corresponding to the first service data unit of a first traffic type; performing logical channel prioritization to select a second service data unit from the plurality of service data units; determining a second traffic type of the second service data unit; and in response to determining the second traffic type, adjusting the discard timer for the first service data unit in a buffer.

The present disclosure is directed to a user equipment. The user equipment includes a storage medium and a processor. The storage medium stores a discard timer and a buffer. The processor is coupled to the storage medium and is configured to: obtain a plurality of service data units including a first service data unit; initialize the discard timer corresponding to the first service data unit of a first traffic type; perform logical channel prioritization to select a second service data unit from the plurality of service data units; determine a second traffic type of the second service data unit; and in response to determining the second traffic type, adjusting the discard timer for the first service data unit in the buffer.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of multi-modal data according to one embodiment of the present disclosure.

FIG. 2 illustrates a schematic diagram of mapping alternatives of QoS flow according to one embodiment of the present disclosure.

FIG. 3 illustrates a schematic diagram of LCP restriction according to one embodiment of the present disclosure.

FIG. 4 illustrates a schematic diagram of LCP restriction according to one embodiment of the present disclosure.

FIG. 5 illustrates a schematic diagram of synchronization maintaining according to one embodiment of the present disclosure.

FIG. 6 illustrates a flowchart of discardTimer adjustment according to one embodiment of the present disclosure.

FIG. 7 illustrates a schematic diagram of discardTimer adjustment according to one embodiment of the present disclosure.

FIG. 8 illustrates a flowchart of discardTimer adjustment according to one embodiment of the present disclosure.

FIG. 9 illustrates a flowchart of discardTimer adjustment based on pdu-SetDiscard according to one embodiment of the present disclosure.

FIG. 10 illustrates a flowchart of a method for timer adjustment in packet transmission according to one embodiment of the present disclosure.

FIG. 11 illustrates a schematic diagram of a communication device according to one embodiment of the present disclosure.

### DESCRIPTION OF THE EMBODIMENTS

Multi-modal data consists of more than one type of data, where there is strong dependency among different types of data. To maintain the dependency of the multi-modal data, the multi-modal data may be proceeded using a single quality of service (QoS) flow or multiple QoS flows. A single QoS flow can maintain the dependency of the multi-modal data easily, but may lose QoS control granularity. Multiple QoS flows can provide a better QoS control granularity, but additional efforts are required to maintain the dependency for inter flow data.

Immersive multi-modal VR application describes the case of a human interacting with virtual entities in a remote environment such that the perception of interaction with a real physical world is achieved. As the asynchrony between different modalities increases, user's sense of presence and realism will decrease. Multi-modal synchronization threshold can be defined as the maximum tolerable temporal separation of two stimuli in the same data burst (or ONSET, packet data unit (PDU) set), wherein one of the stimuli is presented to one sense and the other to another sense, such that the accompanying sensory objects are perceived as being synchronous. Different type SDUs belong to the same data burst (or ONSET, PDU set) are expected to be received without exceed the synchronization threshold.

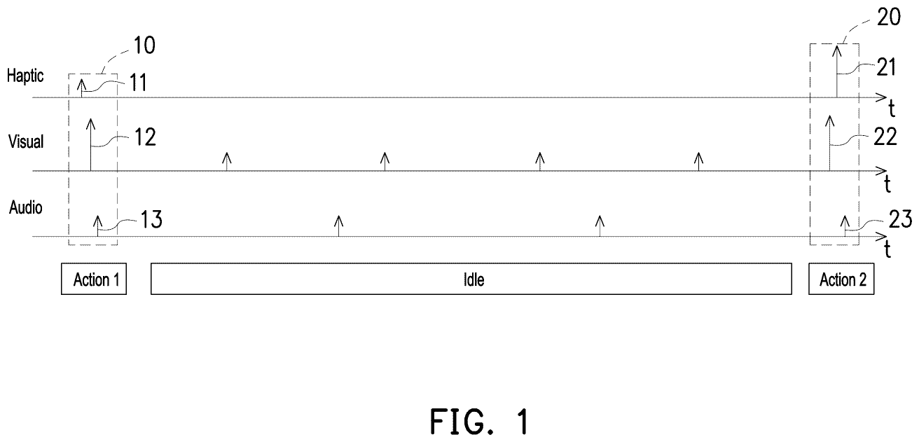

FIG. 1 illustrates a schematic diagram of multi-modal data according to one embodiment of the present disclosure. Assume that the data burst 10 includes the service data unit (SDU) 11 corresponding to the haptic traffic flow, the SDU 12 corresponding to the visual traffic flow, and the SDU 13 corresponding to the audio traffic flow, and the data burst 20 includes the SDU 21 corresponding to the haptic traffic flow, the SDU 22 corresponding to the visual traffic flow, and the SDU 23 corresponding to the audio traffic flow. The latencies between the SDU 11, SDU 12, and SDU 13 are expected to be lower than synchronization threshold since these SDUs belong to the same data burst.

For multi-modal extended reality (XR) applications, radio access network (RAN) becomes a bottleneck in the multi-modal synchronization. Haptic data requires very stringent delay budget and the burst size or periodicity of data bursts of a multi-modal service can be unpredictable and irregular. For example, the data burst 10 can be generated after Action 1 is performed by a user. It is hard to predict when will the user perform Action 2 or when will the data burst 20 be generated. When the user stays idle, some data (e.g., visual traffic or audio traffic as shown in FIG. 1) uncorrelated with any actions may be detected. Because the RAN currently does not have multi-modal awareness, the logical channel prioritization (LCP) allocates resources in a decreasing logical channel (LCH) priority order and cannot support the multi-modal synchronization. That is, the LCP cannot make an appropriate medium access control (MAC) PDU for multi-modal synchronization. Therefore, RAN needs to be enhanced to support synchronization for multi-modal services.

From the point of view of the RAN, data that are related in time will only be in one data burst. A synchronized burst is composed with more than one SDUs from dependent QoS flows. It is reasonable to assume that the interval between a synchronized burst and the subsequent synchronized burst will be much larger than the synchronization threshold of the dependent data. That is, for two adjacent synchronized bursts, the probability that their respective SDUs (or PDUs) exist in a UE's packet data convergence protocol (PDCP) buffer at the same time is very low. Take FIG. 1 as an example, the interval between the data burst 10 and the data burst 20 can be much larger than the synchronization threshold. The probability that SDU 11 (or SDU 12, SDU 13) and SDU 21 (or SDU 22, SDU 23) in the UE's buffer in the same time is very low.

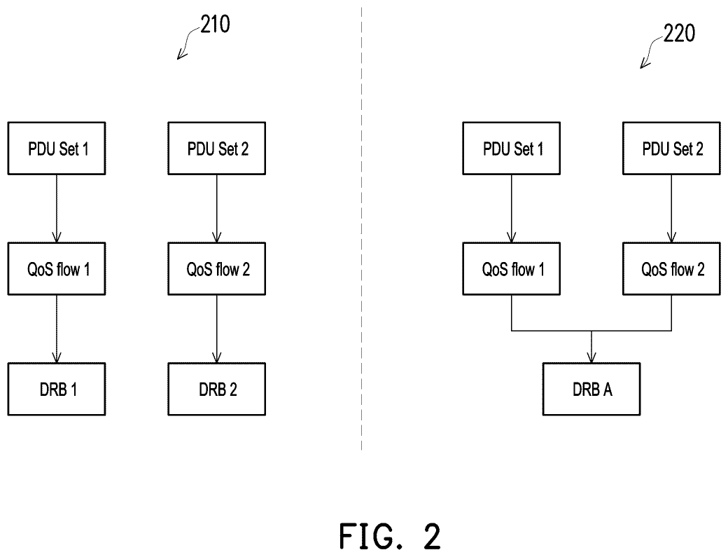

FIG. 2 illustrates a schematic diagram of mapping alternatives of QoS flow according to one embodiment of the present disclosure. In mapping alternative 210, the ratio of the number of QoS flows and the number of data radio bearers (DRBs) can be 1:1, wherein each DRB may be mapped to a corresponding PDCP entity. For example, the QoS flow 1 corresponding to the PDU set 1 and the QoS flow 2 corresponding to the PDU set 2 can be transmitted via different DRBs (e.g., DRB 1 and DRB 2) respectively. In mapping alternative 220, the ratio of the number of QoS flows and the number of DRBs can be N:1, where N is a positive integer greater than 1. For example, the QoS flow 1 corresponding to the PDU set 1 and the QoS flow 2 corresponding to the PDU set 2 can be transmitted via the same DRB (e.g., DRB A).

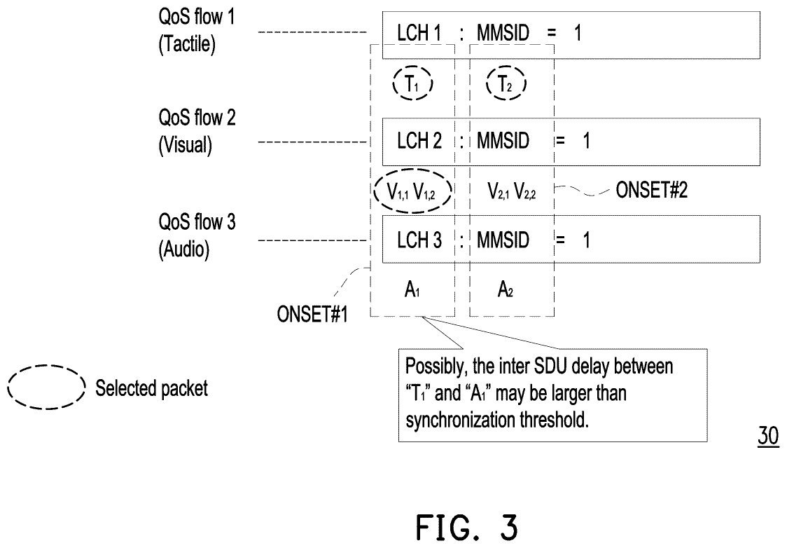

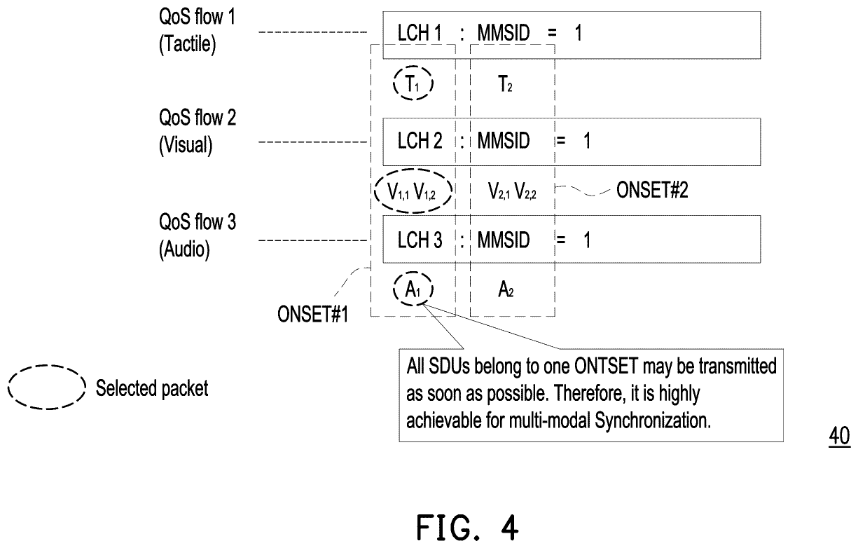

When performing LCP, different packet selection strategies may result in different inter-packet delay among different types of data belonging to the same ONSET (or PDU set, data burst). FIG. 3 and FIG. 4 illustrate schematic diagrams of LCP restriction 30 and LCP restriction 40 according to one embodiment of the present disclosure. Assume that QoS flow 1 (e.g., tactile data), QoS flow 2 (e.g., visual data), and QoS flow 3 (audio data) belong to the same multi-modal service (e.g., QoS flows 1-3 have the same multi-modal service identifier (MMSID)=1); the QoS flow 1 includes SDU T₁ and SDU T₂ to be uploaded; the QoS flow includes SDU V_{1,1}, SDU V_{1,2}, SDU V_{2,1}, and SDU V_{2,2} to be uploaded; the QoS flow 3 includes SDU A₁ and SDU A₂ to be uploaded; SDU T₁, SDU V_{1,1}, SDU V_{1,2}, and SDU A₁ belong to ONSET #1; SDU T₂, SDU V_{2,1}, SDU V_{2,2}, and SDU A₂ belong to ONSET #2; and an uplink (UL) grant is only enough to carry 4 packets. It should be noted that, in the following description, the SDUs belonging to the same data burst or the same ONSET may correspond to the same MMSID.

The LCP restriction 30 may be a strategy of assigning priority to SDUs based on the traffic type. For example, SDUs belonging to tactile data may have the highest priority. If the UE (or transmitting end) performs LCP based on the LCP restriction 30, SDU T₁, SDU T₂, SDU V_{1,1}, and SDU V_{1,2} may be uploaded first. Afterward, SDU V_{2,1}, SDU V_{2,2}, SDU A₁, and SDU A₂ may be uploaded later. Accordingly, the inter-SDU delay between, for example, SDU T₁ and SDU A₁ may be larger than the synchronization threshold.

The LCP restriction 40 may be a strategy of assigning priority to SDUs based on the data burst. For example, SDUs belonging to ONSET #1 may have the highest priority. If the UE performs LCP based on the LCP restriction 40, SDU T₁, SDU V_{1,1}, SDU V_{1,2}, and SDU A₁ may be uploaded first. Afterward, SDU T₂, SDU V_{2,1}, SDU V_{2,2}, and SDU A₂ may be uploaded later. Based on the above, LCP restriction 40 seems to be highly achievable for multi-modal synchronization.

At reception of a PDCP SDU from upper layer (e.g., radio resource control (RRC) layer), the transmitting PDCP entity (e.g., PDCP entity of transmitting end such as UE) may start the discard timer (i.e., discardTimer) associated with the PDCP SDU (if configured) to monitor remaining delay budget. When the discardTimer associated with PDCP SDU expires, the transmitting PDCP entity may discard the PDCP SDU along with the corresponding PDCP data PDU.

For the uplink traffic, the UE may be able to identity data bursts (i.e., ONSET) dynamically. Therefore, the UE may keep the association for SDUs belonging to the same ONSET. The UE may adjust the remaining delay budget to enable the LCP operation for guarantee of multi-modal service synchronization.

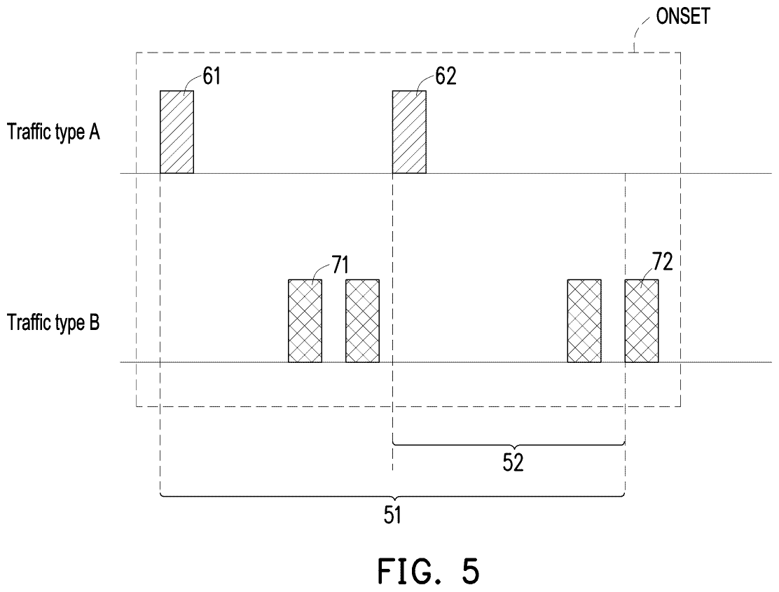

FIG. 5 illustrates a schematic diagram of synchronization maintaining according to one embodiment of the present disclosure, wherein traffic type A and traffic type B are different traffic types. A UE may adjust the PDCP packet discard timer (i.e., discardTimer) to ensure multi-modal service synchronization. In one embodiment, multi-modal service synchronization may be maintained between the first SDU in a PDU set of traffic type A and the last SDU in a PDU set of traffic type B, as shown by interval 51 in FIG. 5. In one embodiment, multi-modal service synchronization may be maintained between the last SDU in a PDU set of traffic type A and the last SDI in a PDU set of traffic type B, as shown by interval 52 in FIG. 5.

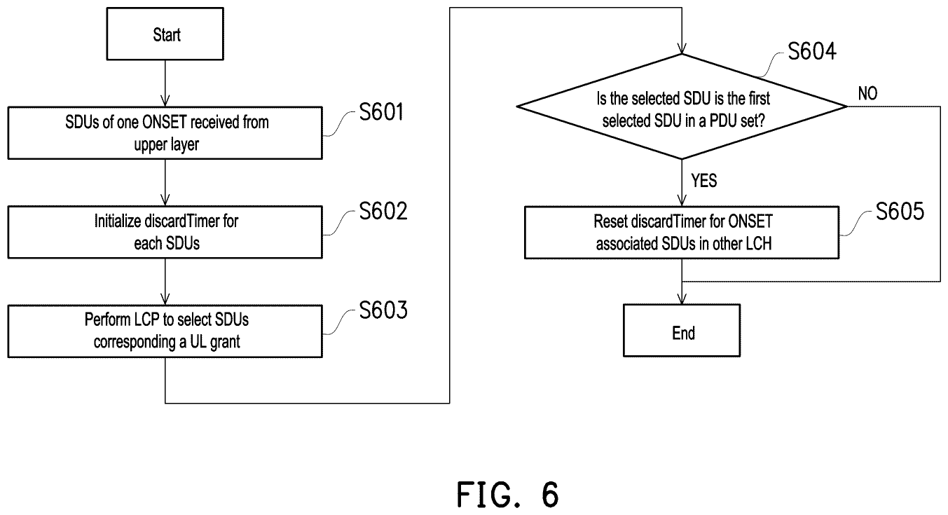

FIG. 6 illustrates a flowchart of discardTimer adjustment according to one embodiment of the present disclosure. The method can be implemented by a communication device operating as a transmitting end (e.g., PDCP entity of UE). Referring to FIG. 5 and FIG. 6, in step S601, a PDCP entity of a UE may obtain or receive a plurality of SDUs of an ONSET from upper layer (e.g., RRC entity of UE). The plurality of SDUs may include SDUs respectively corresponding to different traffic types. For example, the plurality of SDUs may include SDU 61 or SDU 62 corresponding to traffic type A and SDU 71 or SDU 72 corresponding to traffic type B. The traffic type of each SDU may be determined by the PDCP entity based on the information submitted from the upper layer.

In step S602, the PDCP entity may initialize a discard timer (e.g., discardTimer) for each SDU. For example, in response to receiving SDU 61 (or SDU 62, 71, or 72), the PDCP entity may initialize a discardTimer corresponding to the SDU 61 (or SDU 62, 71, or 72). In one embodiment, the SDUs of an ONSET belonging to the same traffic type may share the same discardTimer. For example, in response to receiving SDU 61, the PDCP entity may initialize a discardTimer corresponding to both SDU 61 and SDU 62.

In step S603, the PDCP entity may perform LCP to select one or more SDUs corresponding to a UL grant from the plurality of SDUs, wherein the UL grant may have been obtained earlier by the UE. The selected SDUs may be transmitted via UL resources indicating by the UL grant. For example, the PDCP entity may select SDU 61 for the UL grant after performing LCP.

In step S604, the PDCP entity may determine whether the selected SDU is the first selected SDU in a PDU set (i.e., the first SDU been selected from the PDU set by the PDCP entity). If the selected SDU is the first selected SDU in the PDU set, the PDCP entity may execute step S605. If the selected SDU is not the first selected SDU in the PDU set, the PDCP entity may not adjust a discardTimer. In step S605, the PDCP entity may adjust or reset the discardTimer for an ONSET associated SDU in other LCH's buffer (i.e., the LCH different from the LCH of selected SDU). The PDCP entity may adjust or reset the discardTimer of the SDU in other LCH according to the selected SDU. The PDCP entity may flush an SDU from a PDCP buffer after the adjusted discardTimer corresponding to the SDU has expired.

For example, after selecting SDU 61, the PDCP entity may determine whether SDU 61 is the first SDU in the PDU set of traffic type A. Since SDU 61 is the first SDU in the PDU set of traffic type A, the PDCP entity may reset the discardTimer of the SDU in the LCH of traffic type B. The PDCP entity may reset the discardTimer corresponding to SDU 71 or SDU 72 according to SDU 61, wherein the reception time of SDU 71 or SDU 72 is later than the reception time of SDU 61. For another example, after selecting SDU 62, the PDCP entity may determine whether SDU 62 is the first SDU in the PDU set of traffic type A. Since SDU 62 is not the first SDU in the PDU set of traffic type A, the PDCP entity may not reset the discardTimer corresponding to SDU 72 according to SDU 62.

In one embodiment, the PDCP entity may reset a discardTimer according to the following equation (1), where SyncThres* is the synchronization threshold associated with the traffic type of the selected SDU. If the remaining time of discardTimer is less than SyncThres*, the PDCP entity may maintain the remaining time of discardTimer. If the remaining time of discardTimer is greater than SyncThres*, the PDCP entity may reset discardTimer to be equal to SyncThres*.

$$discardTimer = min \{ remaining time of discardTimer , {SyncThres}^{*} \} \qquad ( 1 )$$

Table 1 is an example of the delay tolerance among different types of multi-modal data. Assume that an ONSET includes an audio SDU and a visual SDU. If the visual SDU is selected firstly by the PDCP entity for UL transmission, the synchronization threshold of the audio SDU may be set to 20 ms. In other words, the delay time between the transmission of the visual SDU and the transmission of the audio SDU should not exceed 20 ms. If the audio SDU is selected firstly by the PDCP entity for UL transmission, the synchronization threshold of the visual SDU may be set to 20 ms. Assume that an ONSET includes an audio SDU and a tactile SDU. If the tactile SDU is selected firstly by the PDCP entity for UL transmission, the synchronization threshold of the audio SDU may be set to 25 ms. If the audio SDU is selected firstly by the PDCP entity for UL transmission, the synchronization threshold of the tactile SDU may be set to 12 ms. Assume that an ONSET includes a visual SDU and a tactile SDU. If the tactile SDU is selected firstly by the PDCP entity for UL transmission, the synchronization threshold of the visual SDU may be set to 20 ms. If the visual SDU is selected firstly by the PDCP entity for UL transmission, the synchronization threshold of the tactile SDU may be set to 30 ms.

TABLE 1

| | audio delay | visual delay |
|---|---|---|
| audio-visual | 20 ms | 20 ms |
| | audio delay | tactile delay |
| audio-tactile | 25 ms | 12 ms |
| | visual delay | tactile delay |
| visual-tactile | 20 ms | 30 ms |

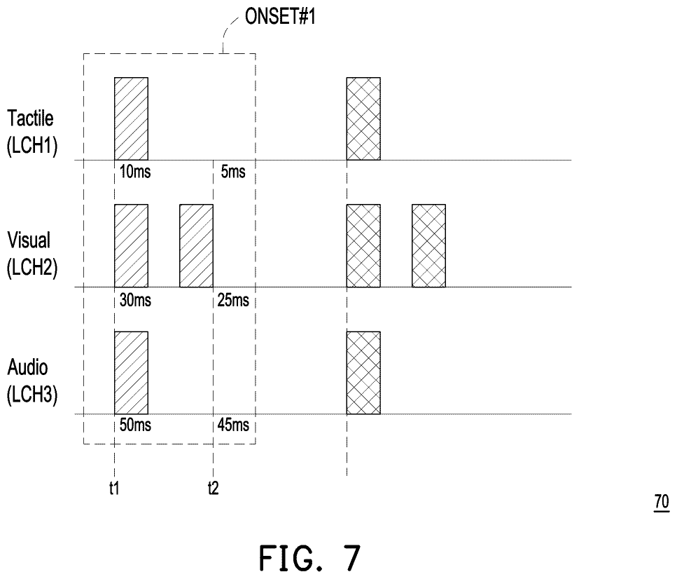

FIG. 7 illustrates a schematic diagram 70 of discardTimer adjustment according to one embodiment of the present disclosure. Referring to FIG. 7 and table 1, when the PDCP entity receives one or more SDUs from upper layer at time point t1, the PDCP may initialize discardTimer for each SDU, wherein the initial value of discardTimer corresponding to tactile QoS flow is assumed to be 10 ms, the initial value of discardTimer corresponding to visual QoS flow is assumed to be 30 ms, and the initial value of discardTimer corresponding to audio QoS flow is assumed to be 50 ms. When the first tactile SDU in ONSET #1 is selected for UL transmission at time point t2 (t2−t1=5 ms), the PDCP entity may reset discardTimer for visual SDU and audio SDU. The discardTimer corresponding to the visual SDU may be set to discardTimer=min {30 ms-5 ms, 20 ms}=20 ms. The discardTimer corresponding to the audio SDU may be set to discardTimer=min {50 ms-5 ms, 25 ms}=25 ms.

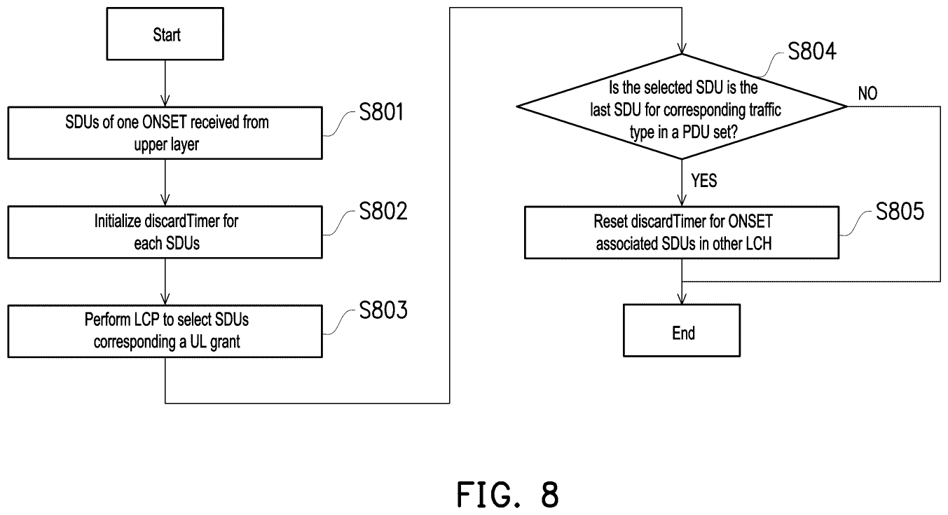

FIG. 8 illustrates a flowchart of discardTimer adjustment according to one embodiment of the present disclosure. The method may be implemented by a communication device operating as a transmitting end (e.g., PDCP entity of UE). Referring to FIG. 5 and FIG. 8, in step S801, a PDCP entity of UE may obtain or receive a plurality of SDUs of an ONSET from upper layer (e.g., RRC entity of UE). The plurality of SDUs may include SDUs respectively corresponding to different traffic types. For example, the plurality of SDUs may include SDU 61 or SDU 62 corresponding to traffic type A and SDU 71 or SDU 72 corresponding to traffic type B. The traffic type of each SDU may be determined by the PDCP entity based on the information submitted from the upper layer.

In step S802, the PDCP entity may initialize a discard timer (e.g., discardTimer) for each SDU. For example, in response to receiving SDU 61 (or SDU 62, 71, or 72), the PDCP entity may initialize a discardTimer corresponding to the SDU 61 (or SDU 62, 71, or 72). In one embodiment, the SDUs of an ONSET belonging to the same traffic type may share the same discardTimer. For example, in response to receiving SDU 61, the PDCP entity may initialize a discardTimer corresponding to both SDU 61 and SDU 62.

In step S803, the PDCP entity may perform LCP to select one or more SDUs corresponding to a UL grant from the plurality of SDUs, wherein the UL grant may have been obtained earlier by the UE. The selected SDUs may transmitted via UL resources indicating by the UL grant. For example, the PDCP entity may select SDU 62 for the UL grant after performing LCP.

In step S804, the PDCP entity may determine whether the selected SDU is the last SDU for corresponding traffic type in a PDU set. If the selected SDU is the last SDU for corresponding traffic type in the PDU set, the PDCP entity may execute step S805. If the selected SDU is not the last SDU for corresponding traffic type in the PDU set, the PDCP entity may not adjust a discardTimer. In step S805, the PDCP entity may adjust or reset the discardTimer for an ONSET associated SDU in other LCH's buffer (i.e., the LCH different from the LCH of the selected SDU). The PDCP entity may adjust or reset the discardTimer of the SDU in other LCH according to the selected SDU. The PDCP entity may flush an SDU from a PDCP buffer after the adjusted discardTimer corresponding to the SDU has expired.

For example, after selecting SDU 62, the PDCP entity may determine whether SDU 62 is the last SDU in the PDU set of traffic type A. Since SDU 62 is the last SDU in the PDU set of traffic type A, the PDCP entity may reset the discardTimer of the SDU in the LCH of traffic type B. The PDCP entity may reset the discardTimer corresponding to SDU 72 according to SDU 62, wherein the reception time of SDU 72 is later than the reception time of SDU 62. For another example, after selecting SDU 61, the PDCP entity may determine whether SDU 61 is the last SDU in the PDU set of traffic type A. Since SDU61 is not the last SDU in the PDU set of traffic type A, the PDCP entity may not reset the discardTimer corresponding to SDU 71 or SDU 72 according to SDU 61.

In one embodiment, the PDCP entity may reset a discardTimer according to the method described in FIG. 8 and the corresponding paragraphs.

In one embodiment, the UE may determine the rules to adjust the discardTimer of an SDU within an ONSET according to pdu-SetDiscard. pdu-SetDiscard is a parameter used to configure the rules for discarding a PDU set. The UE may receive pdu-SetDiscard from a base station (BS) via, for example, an RRC message. If pdu-SetDiscard is not configured to the UE (e.g., pdu-SetDiscard is set to false), the UE may discard a SDU in a PDU set when the corresponding discardTimer is expired. If pdu-SetDiscard is configured to the UE (e.g., pdu-SetDiscard is set to true), the UE may discard the entire PDU set when signaling processing on any SDU in the PDU set fails, including one of SDUs in the PDU set is discarded due to discardTimer expiry.

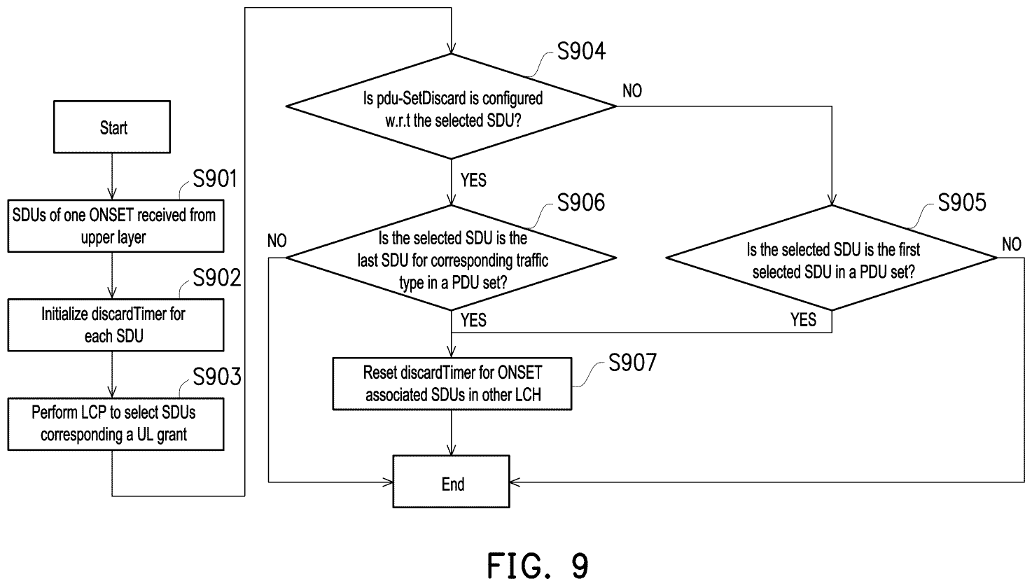

FIG. 9 illustrates a flowchart of discardTimer adjustment based on pdu-SetDiscard according to one embodiment of the present disclosure. The method van be implemented by a communication device operating as a transmitted end (e.g., PDCP entity of UE). Referring to FIG. 6 and FIG. 9, in step S901, a PDCP entity of UE may obtain or receive a plurality of SDUs of an ONSET from upper layer (e.g., RRC entity of UE). The plurality of SDUs may include SDUs respectively corresponding to different traffic types. For example, the plurality of SDUs may include SDU 61 or SDU 62 corresponding to traffic type A and SDU 71 or SDU 72 corresponding to traffic type B. The traffic type of each SDU may be determined by the PDCP entity based on the information submitted from the upper layer.

In step S902, the PDCP entity may initialize a discard timer (e.g., discardTimer) for each SDU. For example, in response to receiving SDU 61 (or SDU 62, 71, or 72), the PDCP entity may initialize a discardTimer corresponding to the SDU 61 (or SDU 62, 71, or 72). In one embodiment, the SDUs of an ONSET belonging to the same traffic type may share the same discardTimer. For example, in response to receiving SDU 61, the PDCP entity may initialize a discardTimer corresponding to both SDU 61 and SDU 62.

In step S903, the PDCP entity may perform LCP to select one or more SDUs corresponding to a UL grant from the plurality of SDUs, wherein the UL grant may have been obtained earlier by the UE. The selected SDUs may be transmitted via UL resources indicating by the UL grant. For example, the PDCP entity may select SDU 61 (or SDU 62) for the UL grant after performing LCP.

In step S904, the PDCP entity may determine whether pdu-SetDiscard is configured with respect to the selected SDU. If pdu-SetDiscard corresponding to the selected SDU is configured to the UE, the PDCP entity may execute step S905. If pdu-SetDiscard corresponding to the selected SDU is not configured to the UE, the PDCP entity may execute step S906.

In step S905, the PDCP entity may determine whether the selected SDU is the first selected SDU in a PDU set. If the selected SDU is the first selected SDU in a PDU set, the PDCP entity may execute step S907. If the selected SDU is not the first selected SDU in the PDU set, the PDCP entity may not adjust a discardTimer.

In step S906, the PDCP entity may determine whether the selected SDU is the last SDU for corresponding traffic type in a PDU set. If the selected SDU is the last SDU for corresponding traffic type in the PDU set, the PDCP entity may execute step S907. If the selected SDU is not the last SDU for corresponding traffic type in the PDU set, the PDCP entity may not adjust a discardTimer.

In step S907, the PDCP entity may adjust or reset the discardTimer for an ONSET associated SDU in other LCH's buffer (i.e., the LCH different from the LCH of the selected SDU). The PDCP entity may adjust or reset the discardTimer of the SDU in other LCH according to the selected SDU.

For example, after determining that pdu-SetDiscard is configured and SDU 61 is selected for the UL grant, the PDCP entity may determine whether SDU 61 is the last SDU in the PDU set of traffic type A. Since SDU 61 is not the last SDU in the PDU set of traffic type A, the PDCP entity may not reset the discardTimer corresponding to SDU 71 or SDU 72 according to SDU 61.

For example, after determining that pdu-SetDiscard is configured and SDU 62 is selected for the UL grant, the PDCP entity may determine whether SDU 62 is the last SDU in the PDU set of traffic type A. Since SDU 62 is the last SDU in the PDU set of traffic type A, the PDCP entity may reset the discardTimer corresponding to SDU 72 according to SDU 62.

For example, after determining that pdu-SetDiscard is not configured and SDU 61 is selected for the UL grant, the PDCP entity may determine whether SDU 61 is the first SDU in the PDU set of traffic type A. Since SDU 61 is the first SDU in the PDU set of traffic type A, the PDCP entity may reset the discardTimer corresponding to SDU 71 or SDU 72 according to SDU 61.

For example, after determining that pdu-SetDiscard is not configured and SDU 62 is selected for the UL grant, the PDCP entity may determine whether SDU 62 is the first SDU in the PDU set of traffic type A. Since SDU 62 is not the first SDU in the PDU set of traffic type A, the PDCP entity may not reset the discardTimer corresponding to SDU 72 according to SDU 62.

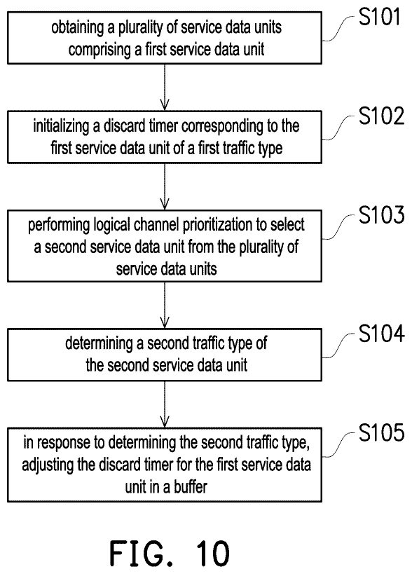

FIG. 10 illustrates a flowchart of a method for timer adjustment in packet transmission according to one embodiment of the present disclosure, wherein the method can be implemented by a transmitting end (e.g., a PDCP entity of a UE). In step S101, obtaining a plurality of service data units comprising a first service data unit. In step S102, initializing a discard timer corresponding to the first service data unit of a first traffic type. In step S103, performing logical channel prioritization to select a second service data unit from the plurality of service data units. In step S104, determining a second traffic type of the second service data unit. In step S105, in response to determining the second traffic type, adjusting the discard timer for the first service data unit in a buffer.

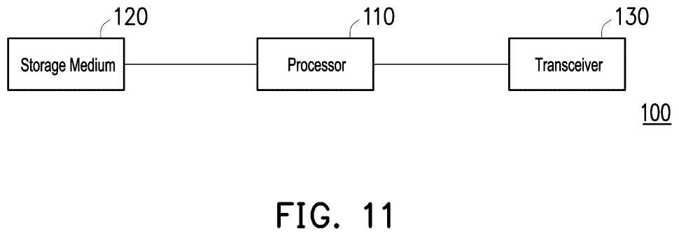

FIG. 11 illustrates a schematic diagram of a communication device 100 according to one embodiment of the present disclosure. The communication device 100 may include a processor 110, a storage medium 120, and a transceiver 130. The processor 110 is coupled to the storage medium 120 and the transceiver 130 and is configured to at least to implement the method as described in FIGS. 1-10 as well as its exemplary embodiment and alternative variations. In one embodiment, the communication device 100 may be implemented as the UE or the BS (e.g., network or network node) as mentioned above.

The processor 110 coupled be implemented by using programmable units such as a micro-processor, a micro-controller, a digital signal processor (DSP), a field programmable gate array (FPGA), etc. The functions of the processor 110 may also be implemented with separate electronic devices or ICs. It should be noted that functions of the processor 110 may be implemented with either hardware or software.

The storage medium 120 may be, for example, any type of fixed or removable random access memory (RAM), a read-only memory (ROM), a flash memory, a hard disc drive (HDD), a solid state drive (SSD) or similar element, or a combination thereof, configured to record a plurality of modules or various applications executable by the processor 110. The storage medium 120 may store a discard timer (e.g., discardTimer) or a buffer (e.g., PDCP buffer).

The transceiver 130 may be configured to transmit and receive signals respectively in the radio frequency. The transceiver 130 may also perform operations such as low noise amplifying, impedance matching, frequency mixing, up or down frequency conversion, filtering, amplifying, and so forth. The transceiver 130 may include one or more digital-to-analog (D/A) converters or analog-to-digital (A/D) converters which are configured to convert from an analog signal format to a digital signal format during uplink signal processor and from a digital signal format to an analog signal formant during downlink signal processing. The transceiver 130 may include an antenna array which may include one or more antennas to transmit and receive omni-directional antenna beams or directional antenna beams.

Based on the above, the disclosed UE may perform LCP to select an SDU based on the transmission priority. After an SDU is selected, the UE may adjust a discard timer for another SDU so as to ensure the synchronization between SDUs corresponding to different traffic types. If pdu-SetDiscard is configured to the UE, the UE may determine that the synchronization among all SDUs in a PDU set must be ensured in order to keep the PDU set. Accordingly, the UE may adjust a discard timer for a specific SDU based on the last SDU of the PDU set in other LCH so as to ensure the synchronization between the last SDU and the specific SDU. The UE may discard the entire PDU set if the specific SDU is not synchronized with the last SDU. On the other hand, if pdu-SetDiscard is not configured to the UE, the UE may determine that the discarding of each SDU in the PDU set can be considered independently. Accordingly, the UE may adjust a discard timer for a specific SDU based on the first SDU of the PDU set in other LCH so as to ensure the synchronization between the first SDU and the specific SDU. The UE may discard only the specific SDU if the specific SDU is not synchronized with the first SDU.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for timer adjustment in packet transmission, suitable for a user equipment, comprising:
obtaining a plurality of service data units comprising a first service data unit;
initializing a discard timer corresponding to the first service data unit of a first traffic type;
performing logical channel prioritization to select a second service data unit from the plurality of service data units;
determining a second traffic type of the second service data unit; and
in response to determining the second traffic type, adjusting the discard timer for the first service data unit in a buffer.

2. The method according to claim 1, wherein the step of adjusting the discard timer for the first service data unit in the buffer comprising:
determining whether the second service data unit is a first selected data unit in a packet data unit set; and
in response to the second service data unit being the first selected data unit in the packet data unit set, adjusting the discard timer according to the second service data unit.

3. The method according to claim 2, wherein the step of determining whether the second service data unit is the first selected data unit in the packet data unit set comprising:
determining whether a pdu-SetDiscard configuration for the second traffic type is configured to the user equipment; and
in response to the pdu-SetDiscard configuration not being configured, determining whether the second service data unit is the first selected data unit in the packet data unit set.

4. The method according to claim 1, wherein the step of adjusting the discard timer for the first service data unit in the buffer comprising:
determining whether the second service data unit is a last data unit of the second traffic type in a packet data unit set; and
in response to the second service data unit being the last data unit of the second traffic type, adjusting the discard timer according to the second service data unit.

5. The method according to claim 4, wherein the step of determining whether the second service data unit is the last data unit of the second traffic type in the packet data unit set comprising:
determining whether a pdu-SetDiscard configuration for the second traffic type is configured to the user equipment; and
in response to the pdu-SetDiscard configuration being configured, determining whether the second service data unit is the last data unit of the second traffic type in the packet data unit set.

6. The method according to claim 1, wherein the step of adjusting the discard timer for the first service data unit in the buffer comprising:
determining whether a remaining time of the discard timer is greater than a synchronization threshold; and
in response to the remaining time being greater than the synchronization threshold, adjusting the discard timer according to the synchronization threshold.

7. The method according to claim 6, wherein the step of adjusting the discard timer for the first service data unit in the buffer further comprising:
in response to the remaining time being less than or equal to the synchronization threshold, maintaining the remaining time of the discard timer.

8. The method according to claim 1, further comprising:
flushing the first service data unit from the buffer after the adjusted discard timer has expired.

9. The method according to claim 1, wherein the plurality of service data units is obtained by a packet data convergence protocol entity of the user equipment from an upper layer entity of the user equipment.

10. The method according to claim 1, wherein the second traffic type is different from the first traffic type.

11. The method according to claim 1, wherein a first multi-modal service identifier corresponding to the first traffic type and a second multi-modal service identifier corresponding to the second traffic type are configured to the user equipment, wherein the step of adjusting the discard timer for the first service data unit in the buffer comprising:
determining whether the first multi-modal service identifier is the same as the second multi-modal service identifier; and
in response to the first multi-modal service identifier being the same as the second multi-modal service identifier, adjusting the discard timer based on the second service data unit.

12. A user equipment, comprising:
a storage medium, storing a discard timer and a buffer; and
a processor, coupled to the storage medium and configured to:
obtain a plurality of service data units comprising a first service data unit;
initialize the discard timer corresponding to the first service data unit of a first traffic type;
perform logical channel prioritization to select a second service data unit from the plurality of service data units;
determine a second traffic type of the second service data unit; and
in response to determining the second traffic type, adjusting the discard timer for the first service data unit in the buffer.
